(19) United States
(12) Patent Application Publication
(10) Pub. No.: US 2003/0035694 A1
(43) Pub. Date: Feb. 20, 2003

(54) Boring bit for boring holes in wood pieces

(76) Inventor: Chao Chin Liao, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/930,980

(22) Filed: Aug. 17, 2001

(51) Int. Cl. B23B 51/02

(52) U.S. Cl. 408/214; 408/213; 408/225; 408/230

(57) ABSTRACT

A boring bit includes a body having a spirally formed flute in an outer periphery thereof and a tool engaging end is connected to a first end of the body. A recess is axially defined in a second end of the body and a radial threaded hole is defined radially in the body and communicates with the recess. A lead portion has an engaging portion on a first end thereof and a threaded lead screw on a second end of the lead portion. The engaging portion is received in the recess and a bolt is engaged with the threaded hole and contacts the engaging portion. The threaded lead screw is easily replaced by removing the bolt.

### FIELD OF THE INVENTION

The present invention relates to a boring bit having a replaceable lead portion connected to the body of the boring bit.

### BACKGROUND OF THE INVENTION

A conventional boring bit 40 for boring holes in wood pieces is shown in FIG. 7 and generally includes a spirally conical body 42 and a threaded lead screw 41 which is connected to an end of the body 42. The threaded lead screw 41 is used to pilot the boring at the beginning of boring. The threaded lead screw 41 bores a hole in the wood pieces when the boring bit 40 contacts the wood pieces and the hole assists the whole boring bit 40 to continuously bore the wood piece at a higher speed on the pre-chosen point. However, because the threaded lead screw 41 has only a small diameter and it bears a large reaction force from the wood pieces so that it could be damaged or broken when boring stiff wood pieces. Once the threaded lead screw 41 is broken, the whole boring bit 40 is to be discarded.

### SUMMARY OF THE INVENTION

In accordance with one aspect of the present invention, there is provided a boring bit which comprises a body having a spirally formed flute and a tool engaging end is connected to a first end of the body so as to be connected to a driving tool. A recess is axially defined in a second end of the body and a radial threaded hole is defined radially in the body and communicates with the recess. A lead portion has an engaging portion on a first end thereof so as to be engaged with the recess of the body, and a threaded lead screw is on a second end of the lead portion. A bolt is engaged with the threaded hole and contacts the engaging portion.

The primary object of the present invention is to provide a boring bit that has a threaded lead screw which is disengagably engaged with the body of the boring bit.

The present invention will become more obvious from the following description when taken in connection with the accompanying drawings which show, for purposes of illustration only, two preferred embodiments in accordance with the present invention.

### BRIEF DESCRIPTION OF THE DRAWINGS

FIG. 1 is a perspective view to show the boring bit of the present invention;

FIG. 2 is an exploded view to show the boring bit of the present invention;

FIG. 3 is a cross sectional view to show the boring bit of the present invention;

FIG. 4 shows that the threaded lead screw of the boring bit of the present invention drills in a workpiece;

FIG. 5 is a perspective view to show another embodiment of the boring bit of the present invention;

FIG. 6 shows that the threaded lead screw of the boring bit as shown in FIG. 5 has a advanced cutting edge which cuts into the workpiece when the threaded lead screw drills in the workpiece, and

FIG. 7 shows that a conventional boring bit wherein the threaded lead screw is broken.

### DETAILED DESCRIPTION OF THE PREFERRED EMBODIMENTS

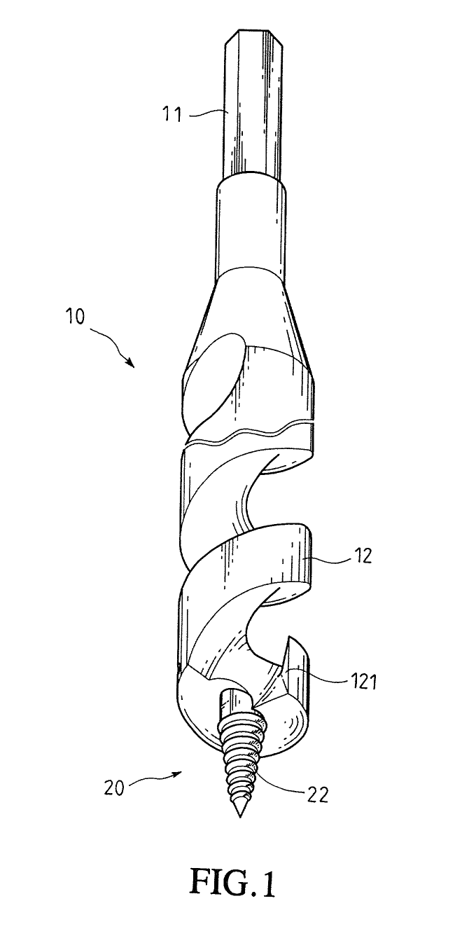

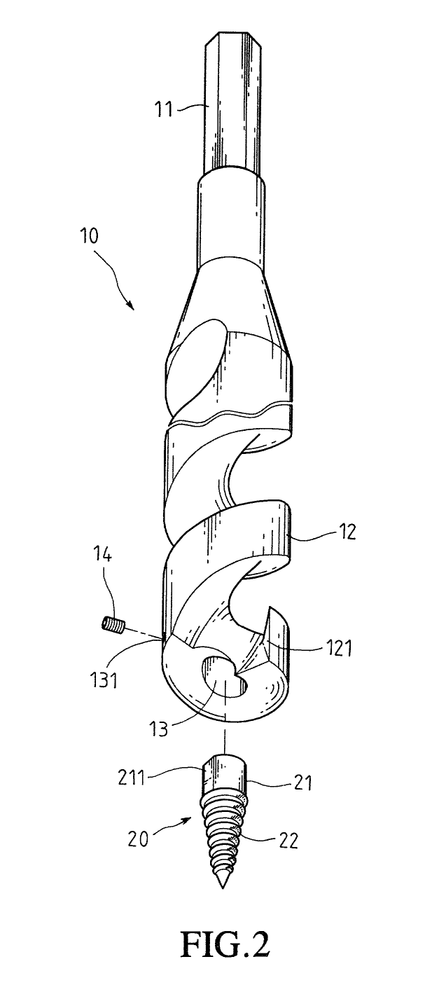

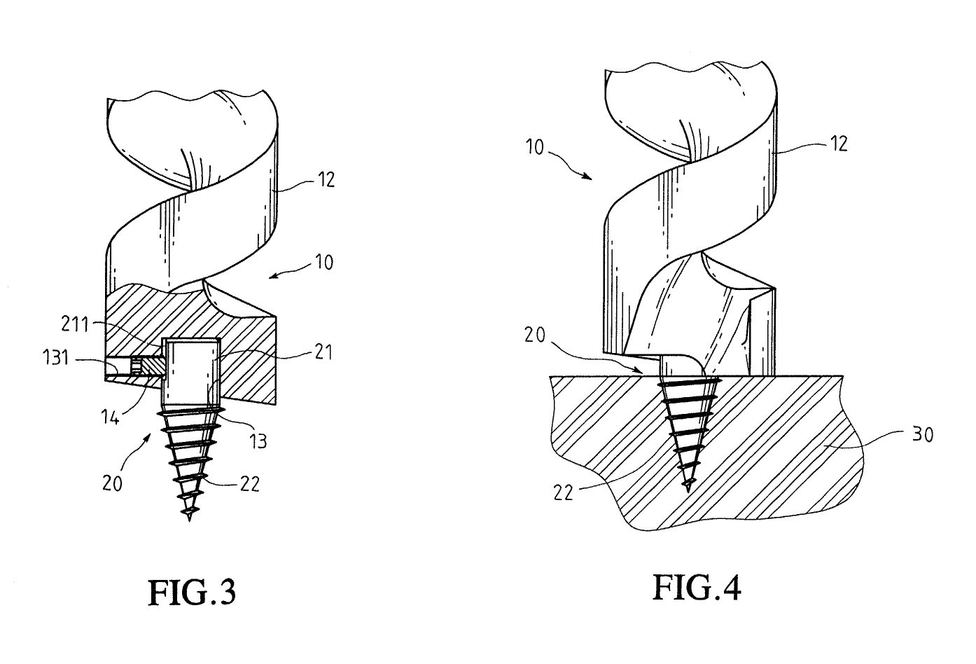

Referring to FIGS. 1 to 3, the boring bit of the present invention comprises a tubular body 10 having a spirally formed flute 12 and a tool engaging end 11 is connected to a first end of the body 12 so as to be engaged with a driving tool (not shown). A recess 13 is axially defined in a second end of the body 10 and a radial threaded hole 131 is defined radially in the body 10 and communicates with the recess 13. A cutting edge 121 is defined in the second end of the body 12.

A lead portion 20 has an engaging portion 21 on a first end thereof and a surface 211 is defined in an outer periphery of the engaging portion 21. A threaded lead screw 22 is formed on a second end of the lead portion 20. The engaging portion 21 is received in the recess 13 and a bolt 14 is engaged with the threaded hole 131 and contacts the surface 211 so as to firmly position the engaging portion 21. Accordingly, when the threaded lead screw 22 is broken or damaged, the user can easily replace a new one by removing the bolt 14. Referring to FIG. 4, when the threaded lead screw 22 drills into the workpiece 30, the cutting edge 121 contacts the workpiece and is ready for cutting into the workpiece 30.

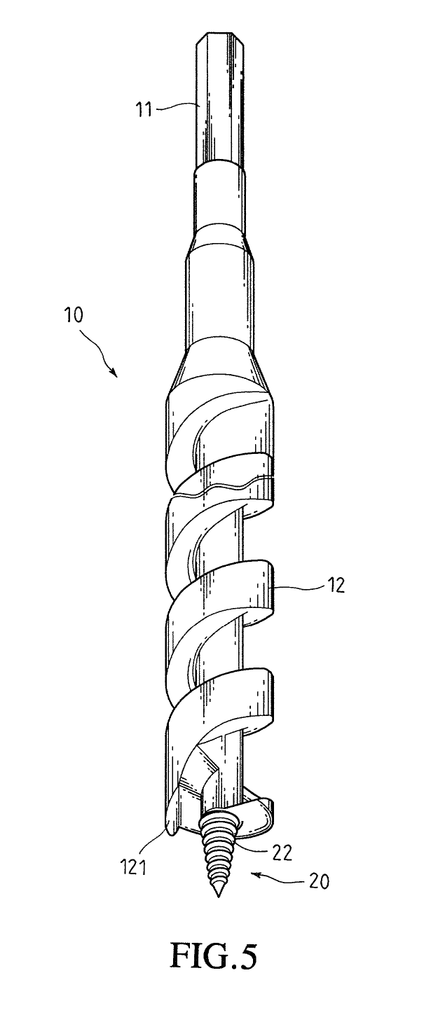

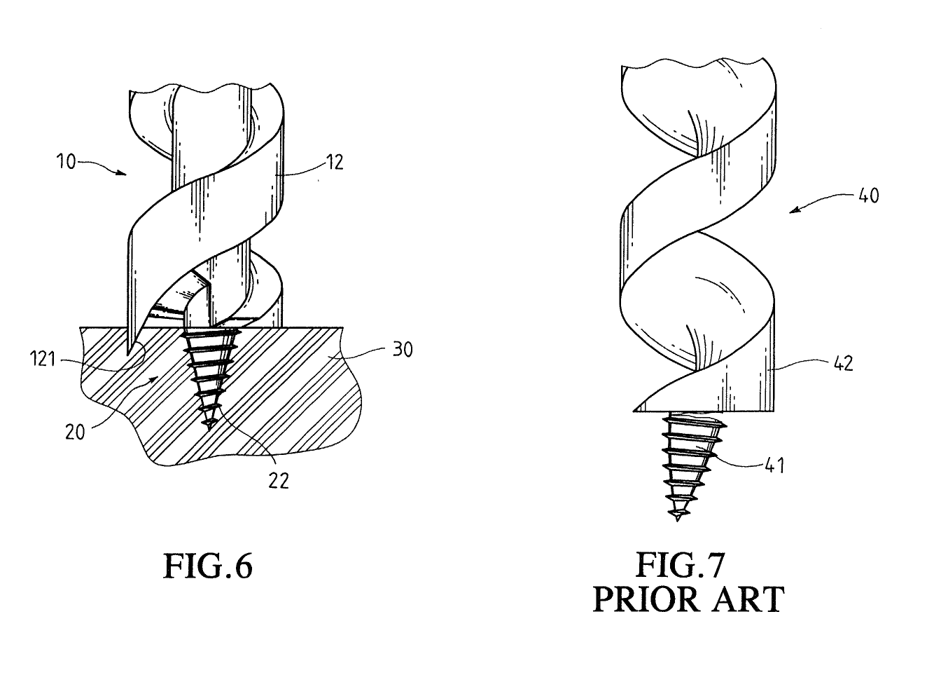

FIGS. 5 and 6 show that the cutting edge 121 can be made to be advanced forwardly beyond the more than one or two revolutions around the threaded lead screw 22. Therefore, when the threaded lead screw 22 completely drills into the workpiece 30, the cutting edge 121 cuts into the workpiece too so that the boring bit of the present invention can continuously and smoothly drill the workpiece.

While we have shown and described the embodiment in accordance with the present invention, it should be clear to those skilled in the art that further embodiments may be made without departing from the scope of the present invention.

What is claimed is:

1. A boring bit comprising:
a body having a spirally formed flute and a tool engaging end connected to a first end of said body, a recess axially defined in a second end of said body and a radial threaded hole defined radially in said body and communicating with said recess, and
a lead portion having an engaging portion on a first end thereof and a threaded lead screw on a second end of said lead portion, said engaging portion received in said recess and a bolt engaged with said threaded hole and contacting said engaging portion.

2. The boring bit as claimed in claim 1, wherein said engaging portion has a surface defined in an outer periphery thereof and said bolt contacts said surface.
